(19) United States
(12) Patent Application Publication
(10) Pub. No.: US 2011/0078313 A1
(43) Pub. Date: Mar. 31, 2011

(54) METHOD AND SYSTEM FOR MANAGING A CONNECTION IN A CONNECTION ORIENTED IN-ORDER DELIVERY ENVIRONMENT

(75) Inventors: Andrei Radulescu, Eindhoven (NL); Despo Galataki, Nicosia (CY)

(73) Assignee: ST-Ericsson SA, Geneva (CH)

(21) Appl. No.: 12/788,205

(22) Filed: May 26, 2010

Related U.S. Application Data
(63) Continuation-in-part of application No. 12/571,018, filed on Sep. 30, 2009.

(51) Int. Cl. G06F 15/16

(52) U.S. Cl. 709/227

(57) ABSTRACT

The present disclosure provides a system and method of establishing a connection between a client and a server in an in-order delivery environment. The disclosed system and method includes a client configured to request establishing a connection by sending a first type of message to a server, and the server is configured to confirm the ability of establishing the connection by sending to the client a second type of message leading to the server being connected. The first type of message starts a first client timer measuring a first predefined time period as a first maximum response time and receipt of the second type of message or a data message stops the first client timer. The connection is closed by sending a third type of message.

### CROSS-REFERENCE TO RELATED APPLICATIONS AND CLAIM OF PRIORITY

The present application is a continuation-in-part of U.S. Non-Provisional patent application Ser. No. 12/571,018, filed Sep. 30, 2009, entitled “METHOD AND SYSTEM FOR MANAGING A CONNECTION IN A CONNECTION ORIENTED IN-ORDER DELIVERY ENVIRONMENT”. Non-Provisional patent application Ser. No. 12/571,018 is assigned to the assignee of the present application and is hereby incorporated by reference into the present application as if fully set forth herein. The present application hereby claims priority under 35 U.S.C. §119(e) to U.S. Non-Provisional patent application Ser. No. 12/571,018.

### TECHNICAL FIELD

The present disclosure relates to a method and system for communication among components in a multi-component system interconnected by a network featuring in-order delivery of communicable items.

### BACKGROUND

In high integrated systems that are currently developed high bandwidth communication capacity is a prerequisite as a performance requirement. Furthermore the system developer pursuing a second source principle must be able to select the components of his design from any manufacturer and at the same time requires them to interoperate flawlessly. This leads to the formation of standardization organizations founded by a plurality of manufacturers active in the field that defines standards for components and intercommunication thereof. One such a standardization organization is the Mobile Industry Processor Interface Alliance (MIPI®). Currently this organization groups around 150 manufacturers working on the details of mobile systems intercommunication. Some information will be available at http://www.mipi.org/ on the WorldWideWeb.

In order to standardize intercomponent communication the MIPI® alliance has defined UniPro^{SM} as a serial high-speed link for connecting devices in a mobile system. The UniPro^{SM} standard is under steady development and currently standard version 1.0 is released. Some information about the features of the various versions of the standard is available on the Internet encyclopaedia at http://en.wikipedia.org/wiki/Unipro on the WorldWideWeb.

By providing an interconnection and communication standard the manufacturers are much more flexible in developing their systems and able to mix and match components well suited for different requirements and provided by different vendors. The UniPro standard or Unified Protocol is directed to chip-to-chip networks that make use of high speed serial links. It is defined to be a general purpose communication protocol that solves the general interconnect problems such as error handling, flow control, routing and arbitration.

Currently UniPro offers connection-oriented communication which requires a connection to be set up, while at the same time allocating a state and other resources such as buffers. Usually connections implement a credit end-to-end flow control to prevent the buffers involved in communication from overflowing. This, in combination with the use of a reliable network guaranteeing no data loss or corruption secures a reliable communication service to the user.

For future developments of UniPro versions are foreseeable that provide a real-time traffic class, having a consequence of limiting the number of layer 2 retransmissions thereby ensuring a time limit for the delivery of a packet by sacrificing a guarantee for the data delivery itself, because limiting the number of layer 2 retransmission creates a very small probability of fragments of data to not being delivered. Higher layers of the UniPro applications will have to take care of the missing fragments, when they receive corresponding reports. Reliable and real-time traffic classes being based on connection-oriented communication require a protocol to initiate maintain and terminate a connection. At present from the transmission control protocol TCP a three-way handshake is known. Details are published in the transmission control protocol, DARPA Internet program, protocol specification by Information Sciences Institute, University of Southern California, IETF request for comments #793, September 1981. However, TCP is much different from the Unified Protocol as it has to cope with a high unreliability which is intrinsic to the network and therefore needs to take precautions in the protocol to cope with such unreliabilities. TCP also assumes no order in the data delivery, since e.g., packets may take different routes in the network. Therefore, TCP uses very large sequence numbers as well as a maximum packet lifetime to ensure the management of connections. UniPro however is mostly operated in small networks of typically up to 10 nodes and provides in-order communication. Therefore, it is possible to use less overhead than with normal protocols and achieve simplicity without sacrificing functionality.

Also known in the art is the ATM connection setup which is disclosed in the ITU-T Q.2931 at B-ISDN application protocols for access signalling, ITU-T recommendation Q.2931, Feb-1995. The related connection setup uses a mechanism which is similar to the one used in TCP, using sequence numbers which are called reference in ATM, however ATM also is based on large sequence numbers which creates a message overhead and thus takes bandwidth from the communication channel.

### SUMMARY

It is an object of the present disclosure to provide an alternative method and system for managing a connection in a connection-oriented in-order delivery environment which allows an adequate allocation of resources and the establishing and terminating of connections with a minimum of message overhead.

This problem is solved by a method for managing the connection in a connection-oriented in-order delivery environment, wherein

a) a client requests establishing a connection by sending a first type of message (1140) to a server;

b) the server confirms the ability of establishing the connection by sending to the client a second type of message leading to the server being connected;

c) wherein sending the first type of message starts a first client timer measuring a first predefined time period as a first maximum response time and receiving the second type of message or a data message stops the first client timer; and

d) wherein the connection is closed by sending a third type of message.

The present disclosure also provides a system for managing a connection in a connection-oriented in-order delivery environment comprising:

a server, a client, a network with in-order delivery; wherein the server is adapted to perform any of the activities of the method described above associated to the server and the client is adapted to perform any of the activities of the method described above associated to the client.

The present disclosure includes a computer program product for carrying out any of the methods of the disclosure on a server, a client, a router etc.

The present disclosure also includes a non-transitory machine readable signal storage medium storing the computer program product described above. For example the non-transitory machine readable signal storage medium may be an optical disk such as a CDROM a DVDROM, or a magnetic tape memory, a magnetic disk memory such as a hard disc or diskettes, solid state memory such as a USB memory stick, flash memory etc.

Advantageous further embodiments of the disclosure are given in the dependent claims.

Expediently the method according to the present disclosure provides a minimum number of messages and protects a dropping of the first message by the server. In this manner although using a reliable network the method protects against a busy server that has no resources available for dealing with the connection, due to e.g. processing another connection.

Expediently according to a further embodiment of a method according to the present disclosure in case a first predefined time period expired another first type of message is sent to the server to guarantee establishing of the connection within the shortest possible time and at the same time dealing with a dropping of the first type of message by the server in the first transmission while allowing the server a sufficient amount of processing time.

Advantageously according to a further embodiment of a method according to the present disclosure receiving a second type of message leads to the client being connected while sending a fourth type of message allows the method to deal with unreliable networks or with real-time traffic classes to communicate to the server that the confirmation message has been received.

Beneficially the confirmation message according to a further embodiment of the method of the present disclosure in the form of the second type of message from the server to the client is safeguarded by a first server timer measuring a second predefined time period to protect the connection establishment from a loss of this message, while receiving a fourth type of message as a confirmation from the client that the confirmation message from the server has been received stops the first server timer. In this manner a minimum number of messages guarantee the secure establishment of a connection.

Expediently according to a further embodiment of the method according to the present disclosure the server generates a fifth type of message and sends it to the client in case it is not able to establish a connection due to unavailable resources, because of dealing with another connection, or high processing load of another application. This message when received at the client allows it advantageously to close the connection and thus provides a method to put the client in a defined state, while the server is unavailable.

Advantageously according to a further embodiment of a method according to the present disclosure a second client timer measuring a third predefined time period is started, when a third type of message is sent, in order to secure a defined termination of the connection and to take appropriate measures, once no response to the third type of message is received in the third predefined time period.

Beneficially according to a further embodiment of a method according to the present disclosure when the server receives the third type of message it sends a sixth type of message to the client in order to confirm the reception of the third type of message thus a close structured handling and management of the connection establishing and termination is secured.

Expediently according to a further embodiment of a method according to the present disclosure the sending of the sixth type of message starts a second server timer to safeguard the secure communication with the client in this case, once a non-reliable network is used for transmitting the message, respectively a network with a traffic class for real-time communication.

Beneficially according to a further embodiment of a method of the present disclosure, the second client timer is stopped, once the client receives the sixth type of message and thus knows, that the server is closing the connection while at the same time a seventh type of message is sent to the server in order to confirm the reception of the sixth type of message and to ensure a defined status as well at the server as at the client.

Advantageously according to a further embodiment of a method of the present disclosure any message exchanged between the client and the server is capable of passing through a router, to enhance the flexibility in the communication between the client and the server while at the same time allowing to define the requested bandwidth for the connection depending on the application, respectively traffic class. At the same time the router provides for only forwarding the message received, once the required bandwidth is available.

Expediently according to a further embodiment of the method according to the present disclosure, once the router is available to provide the requested bandwidth, it protects against further bandwidth allocation until it receives a confirmation message from the server which was addressed by the client, while rejecting communication from other servers and clients. In this manner, the bandwidth allocation is secured from access by other potential communication partners.

Advantageously a further embodiment of the method according to the present disclosure allows it the client to be addressed by an application client initiating the messages at the client, while the server communicates with an application server and thus establishing communication between an application server and an application client by means of the client and the server exchanging messages for communication establishment in order to provide for a data exchange via the established connection between the application client and the application server.

Advantageously a system according to the present disclosure provides a server and a client as well as a network with in-order delivery in a minimum configuration to execute the actions of the method according to the present disclosure.

Advantageously a further embodiment of the system according to the present disclosure provides a router to extend the flexibility and the communication distance between the client and the server while making use of embodiments of the method according to the present disclosure.

Advantageously according to a further embodiment of the system of the present disclosure acknowledgement messages that are not used at the same time during communication are saved as only one message in one format and in the communication context provide for the right activity at the server respectively client. As well the server timers and the client timers that are not running at the same time may also only be implemented as respectively one server timer and one client timer that are activated when required and then implement the first respectively second respectively server respectively client timer in the message exchange according to the method of the present disclosure and its embodiments.

### BRIEF DESCRIPTION OF THE DRAWINGS

Below examples of embodiments of the present disclosure will further be described based on examples depicted in drawings. Herein

FIG. 1 shows a typical message exchange taking place in a reliable network;

FIG. 2 shows a state machine depicting examples of states and state transitions in a reliable network;

FIG. 3 shows examples of states and state transitions of a server in a reliable network;

FIG. 4 shows a message flow as an example in an unreliable network;

FIG. 5 shows states and state transitions as an example of the client in an unreliable network;

FIG. 6 shows an example of states and state transitions of a server in an unreliable network;

FIG. 7 shows an example of a message flow between server client and router including bandwidth allocation;

FIG. 8 shows an example of a message flow between a client and a server in an unreliable network while messages pass through a router;

FIG. 9 depicts states and state transitions as an example of a client in an unreliable network including a router in the message flow;

FIG. 10 explains states and state transitions of a server as an example in an unreliable network containing a router in the message flow;

FIG. 11 depicts and states and state transitions as an example of a router included in the message flow between a client and a server in an unreliable network;

FIG. 12 shows an example of a message exchange between a client and a server in a reliable network when the server is busy;

FIG. 13 shows an example of a message exchange between a client and the server when the first type of message gets lost;

FIG. 14 gives an example of a message exchange between a client and server where the second type of message is lost;

FIG. 15 depicts an example of a message flow between a client and the server, where the server application has crashed;

FIG. 16 gives an example of a message flow between a client and the server, in an unreliable network where the server is busy;

FIG. 17 depicts an example of a message exchange between a client and a server, where a protocol error occurs;

FIG. 18 depicts an example of a first error taking place in an unreliable network including a router;

FIG. 19 depicts a second error as an example taking place in the communication between a client and a server including a router on the path;

FIG. 20 shows a third example of a communication error occurring between a client and a server having a router in between;

FIG. 21 gives a fourth example of a communication error that occurs in the communication between a client and a server, the message exchange passing through a router;

FIG. 22 shows a further message flow as an example in an unreliable network; and

FIG. 23 shows another message flow as an example in an unreliable network.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

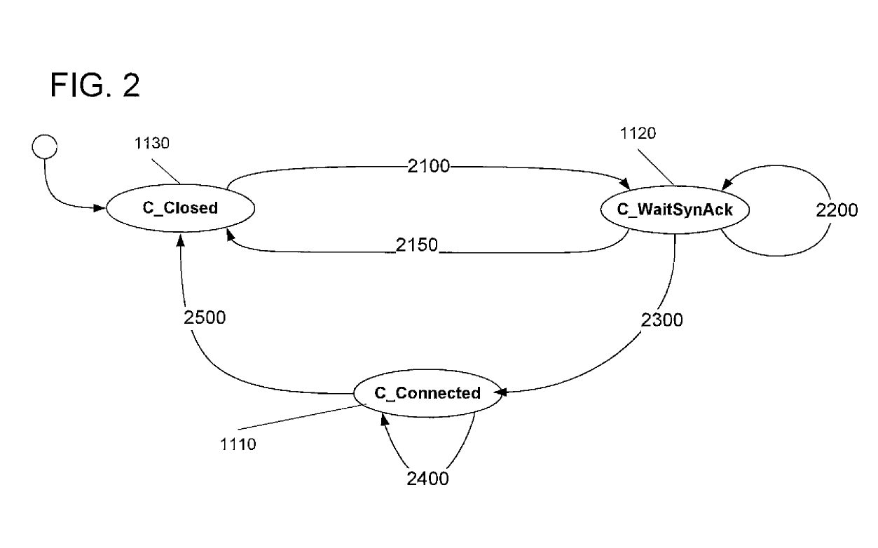

Throughout the description of the drawings which relate to state machines as in FIGS. 2, 3, 5, 6, 9 10 and 11 for the sake of efficiency the following syntax is used for explaining a trigger of a state transition and an event generated by it:

A format like <trigger>/<action> is used for the notation in the state machines. Here <trigger> serves as a placeholder of an input trigger which serves as a trigger which led to the corresponding transaction. Further <action> serves as a placeholder for a set of the resulting events that are associated with the transaction.

Where the term “comprising” is used in the present description and claims, it does not exclude other elements or steps. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

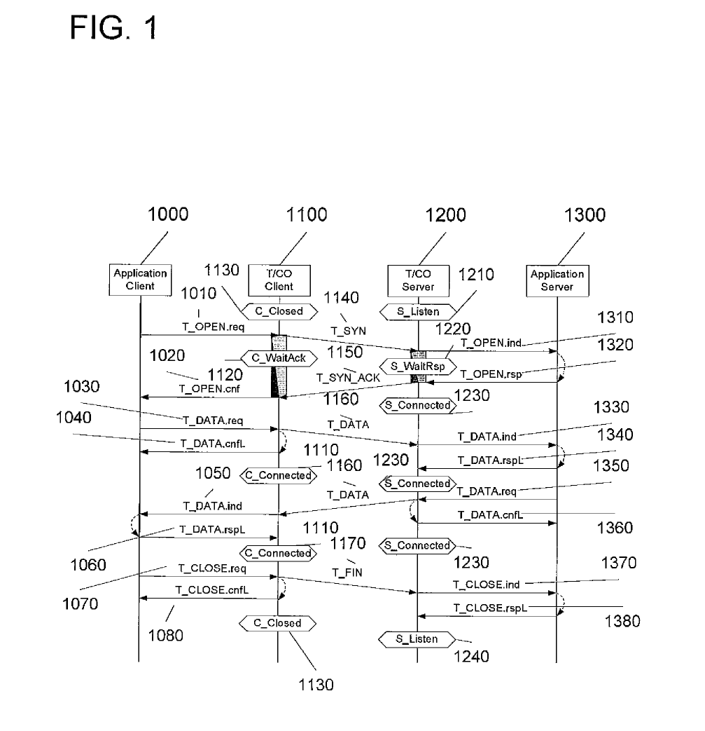

FIG. 1 shows an example of a message flow for connection management according to an embodiment of the present disclosure in a reliable network. Throughout the discussion of the drawings the same reference signs will be used for the same entities in all of the drawings and a redundant description thereof will be omitted for the sake of efficiency.

As FIG. 1 exemplifies an application client 1000 communicates with a client 1100, a server 1200 and an application server 1300 using a reliable network. The network may be a simple link, or may contain one or more routers. However, for simplicity, no router is depicted in FIG. 1. The application client 1000 sends a message 1010 “T_OPEN.req” to the client 1100 which at that time is in a state 1130 of “C_Closed” to initiate the establishment of a connection. At the client 1100 a timer is started once a first type of message 1140 “T_SYN” is sent to the server 1200 which at that time is in an “S_Listen” state. The server generates a message “T_OPEN.ind” 1310 to the application server 1300 which in case of being able to handle the data replies with a message 1320 to the server “T_OPEN.rsp”. The server 1200 measures the time interval between messages 1310 and 1320 with a first server timer while being in a state 1220 “S_WaitRsp”. Receiving the message 1320 the first server timer is stopped, which measures a second predefined time period and a second type of message 1150 “T_SYN Ack” is sent to the client 1100 stopping the first client timer which had been started when the message 1140 was generated being in a state 1120 “C_WaitAck” and generating a message 1020 “T_OPEN.cnf”. The server 1200 now being in a state 1230 “S_Connected” now is connected. Now the application client starts sending a request for transmission of data 1030 “T_DATA.req” which is confirmed by the client 1100 with a confirmation message 1040 “T_DATA.cnfL”. The server 1200 receives the transmitted data 1160 “T_DATA” and sends to the application server the data from the application client 1330 “T_DATA.ind” which responds with a message 1340 “T_DATA.rspL” leaving the server in an “S_Connected” state and the client in an “T_Connected” state 1110.

Data may also be requested from the application server by sending a message 1350 “T_DATA.req” to the server 1200 which is forwarded to the client 1100 as a message 1160 “T_DATA” and from there on forwarded to the application client as a message “T_DATA.ind” 1050 prompting the application client to respond with a message 1060 “T_DATA.rspL” to the client 1100 which is in a “C_Connected” state 1170.

To terminate the connection the application client sends a message 1070 “T_CLOSE.req” confirmed by the client 1100 with a message 1080 “T_CLOSE.cnfL” which generates a message 1170 “T_FIN” to the server 1200 responding to the application 1300 with an indication of the connection close 1370 “T_CLOSE.ind” confirmed by the server 1300 with a message 1380 “T_CLOSE.rspL” transferring the server to a state 1240 “S_Listen”. Alternatively, the connection may be closed by the server 1200 by sending a message 1170 “T_FIN” when this is requested by the application server 1300 with a message 1070 “T_CLOSE.req” (confirmed by message 1080 “T_CLOSE.cnfL”) and indicated with a message 1370 “T_CLOSE.ind” (responded with message 1380 “T_CLOSE.rspL”).

The client remains in a state 1130 “C_Closed”. The timer between messages 1140 and 1150 is required even though a reliable network forms the basis of the communication as the first type of message 1140 may be dropped by the server in case there are no resources available to process the message. The timer run by the server between the messages 1310 and 1320, measuring the second predefined time period is optionally available to supervise if an application at the application server which is required in the communication has crashed or is not available for another reason.

Expediently the client 1100 should provide resources for the reception of message 1150 which is prone to arrive after sending the message 1140. In this manner advantageously at the server 1200 no timer is needed to supervise the proper transmission of the message 1150. Similarly, the client 1100 and/or server 1200 should provide resources for the reception of message 1170. In this manner, the sender of the message 1170 needs no timer to protect against the transmission loss of message 1170.

FIG. 2 shows a state machine associated to the message flow demonstrated in FIG. 1 as an example of states and state transitions that can be adopted by the client.

In order to further explain the notation of the state machines in this description an example referring to FIG. 2 is given, which is however also applicable in an analogous manner to the other Figures representing state machines.

Here in FIG. 2, the client transition 2100 from state 1130 to state 1120 is triggered by the reception of T_OPEN.req (my_server) from the application client 1000, and also leads to transmitting T_SYN (to:my_server) to the server 1200 and starting Timer_SYN at the client 1100. With the above notation, this is denoted as 2100: T_OPEN.req (my_server)/T_SYN (to:my_server), start Timer_SYN.

As another example, the trigger event for transition 2200 is the expiration of Timer_SYN, and also leads to transmitting T_SYN (to:my_server) to the server 1200 and restarting Timer_SYN at the client 1100. This is denoted as 2200: timeout Timer_SYN/T_SYN (to:my_server), restart Timer_SYN.

Being in a state 1130 the client may transfer to a state 1120 “C_WaitSynAck” corresponding to 2100: T_OPEN.req (my_server)/T_SYN (to:my_server), start Timer_SYN. The client remains in the state 1120 corresponding to 2200: timeout Timer_SYN/T_SYN (to:my_server), restart Timer_SYN, whereas a transition back to the state 1130 happens according to 2150: T_SYN_ERR from:my_server)/T_OPEN.cnf (error), stop Timer_SYN. A transition from the state 1120 to the state 1110 “C_Connected” takes place according to 2300: T_SYN_ACK (from:my_server)/T_OPEN.cnf (ok), stop Timer_SYN or 2300: T_DATA (from:my_server)/T_OPEN.cnf (ok), stop Timer_SYN, T_DATA.ind, whereas the client stays in the state 1110 corresponding to 2400: T_DATA.req/T_DATA (to:my_server), or 2400: T_DATA (from:my_server)/T_DATA.ind and transits to a state 1130 by 2500: T_CLOSE.req ( )/T_CLOSE.cnf, T_FIN (to:my_server).

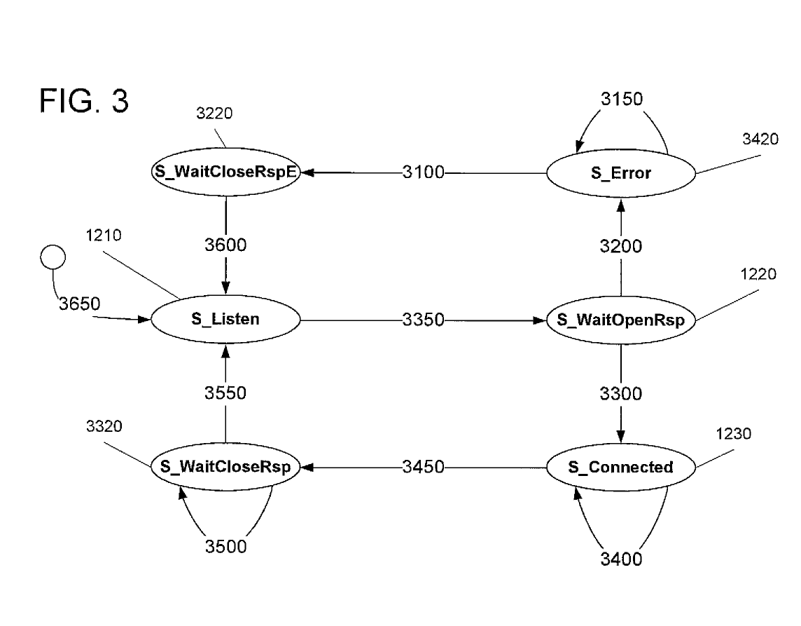

FIG. 3 shows a state machine as an example of states and state transitions a server can adopt in the context of the message flow shown in FIG. 1.

A state “S_WaitCloseRspE” 3220, a state 3420 “S_Error”, a state 1220 “S_WaitOpenRsp”, a state 1230 “S_Connected” and further states 3320 “S_WaitCloseRsp” and a state 1210 “S_Listen” are shown.

Transitions from state 1210 to state 1220 occur by 3350: T_SYN (from:my_client)/T_OPEN.ind (my_client), start Timer_Rsp; from state 1220 to 3420 by 3200: timeout Timer_Rsp/stop Timer_Rsp, T_SYN_ERR (to:my_client); and from state 1220 to state 1230 corresponding to 3300: T_OPEN.rsp ( )/stop Timer_Rsp, T_SYN_ACK (to:my_client). A state transition from state 3420 to state 3220 occurs according to 3100: T_OPEN.rsp ( )/T_CLOSE.ind ( )

Further transitions occur from state 1230 to 3320 corresponding to 3450: T_FIN (from:my_client)/T_CLOSE.ind ( ) and from state 3320 to state 1210 by 3550: T_CLOSE.rsp/T_FIN (to:my_client). State 1210 is initially triggered by the event 3650: T_LISTEN.req/-. The server stays in state 3420 according to transition, 3150: T_SYN (from:any_client)/T_SYN_ERR (to:any_client). The server stays in state 1230 according to transition 3400: T_DATA.req (data)/T_DATA (to:my_client, data), or 3400: T_DATA (from:my_client, data)/T_DATA.ind (data), or 3400: T_SYN (from:my_client)/T_SYN_ACK (to:my_client) or 3400: T_SYN (from:other_client)/T_SYN_ERR (to:other_client). The server stays in state 3320 according to transition 3500: T_DATA.req (data)/T_DATA (to:my_client, data), or 3500: T_SYN (from:other_client)/T_SYN_ERR (to:other_client).

For instance, in the state 3320 the server is still able to send data, but will not receive any more data from the client.

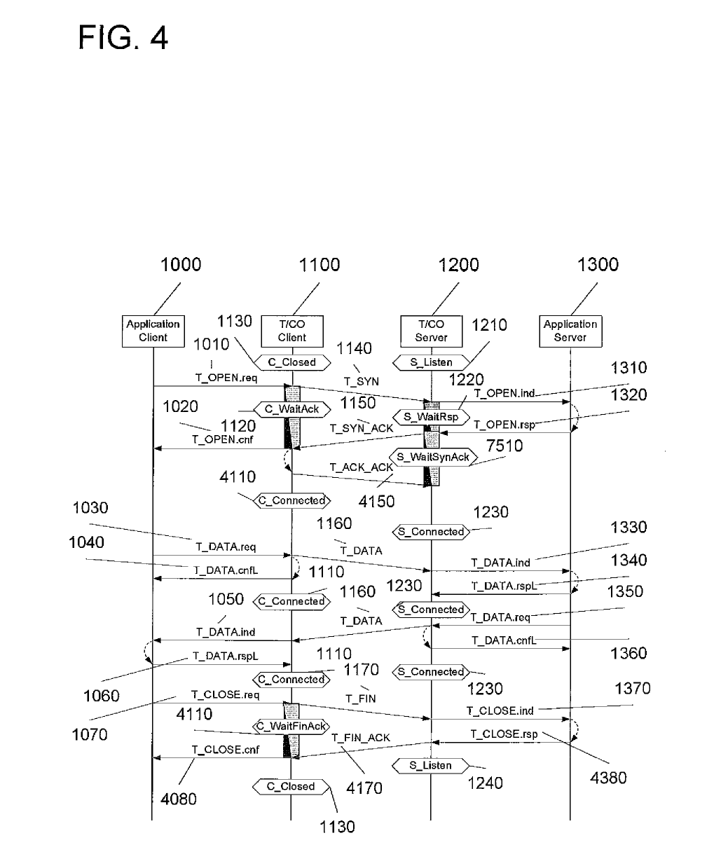

FIG. 4 shows an example of a message flow of an embodiment according to the present disclosure which takes place in an unreliable network, respectively a network that restricts the number of layer 2 retransmissions.

As can be easily identified in comparison with FIG. 1 most of the messages that are exchanged are the same. Due to that fact, a focus is being placed on the differences in the message flow that separates the messages needed in a reliable network from the messages needed to establish a connection in an unreliable network. In case of an unreliable network additional timers and messages are preferably provided to compensate for the unreliability and to secure the establishment of a connection. In this case the client 1100 generates a fourth type of message 4150 “T_ACK_ACK”. This fourth type of message is provided in case of an unreliable network conducting the message flow to supervise the proper transmission of the second type of message 1150. The proper and timely transmission of the fourth type of message is evaluated by a second server timer running at the server 1200 while being in a state 7510 “S_WaitSynAck”. In this case the client transits in a state 4110 “C_Connected” after having transmitted the fourth type of message 4150.

Another particularity of this message flow is located in the termination of the connection where the proper response to the third type of message 1170 during termination of the connection is supervised by a timer while the client itself is in a state 4110 “C_WaitFinAck”. The second client timer is stopped, once the message 4170 “T_FIN_ACK” is received from the server 1200 acknowledging the termination of the connection.

In case of basing the message transfer on an unreliable network the links may discard packets. This may be the case for a traffic class which has a bounded number of retransmissions for instance 0 or 1 to bound the message delivery time. Due to this procedure occasionally fragments or an entire message will be lost or messages will be delivered with known errors in their payload. Thus also connection management messages may be discarded without processing. In particular here the second type of message 1150 from the server should be preferably protected, because in an error case due to a loss the server may remain in an “S_Connected” state 1230 after being at first busy and then becoming available with a second type of message 1150.

This may lead to a case where the server assumes being connected and starts sending data to a client which is not connected and thus not prepared to receive data.

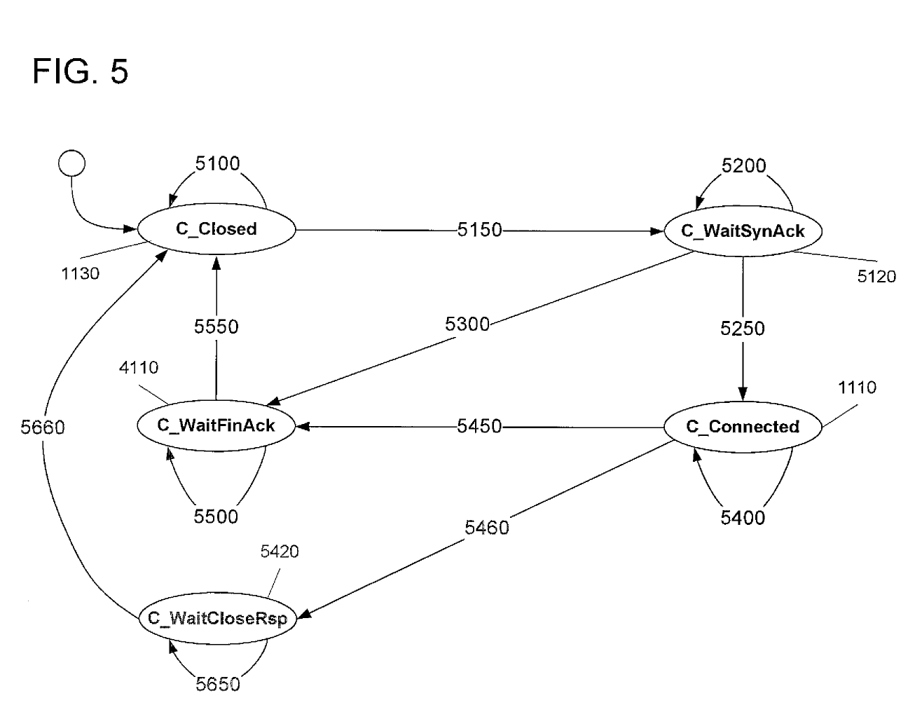

FIG. 5 shows a state machine depicting examples of states and transitions in between states for a client associated to the message flow shown in FIG. 4.

In this case the situation present in an unreliable network, shown in this embodiment shows as a difference compared to the client in a reliable network which was depicted in FIG. 2 the addition of the state 4110 in the context of terminating the connection “C_WaitFinAck”. Further states are 1110 “C_Connected, 1130 “C_Closed”, 5120 “C_WaitSynAck” and 5650 “C_WaitCloseRsp”.

A transition from state 1130 to state 5120 corresponds to 5150: T_OPEN.req (my_server)/T_SYN (to:my_server), start Timer_SYN. A transition from a state 5120 to a state 1110 occurs corresponding to 5250: T_SYN_ACK (from:my_server)/T_ACK_ACK (to:my_server), T_OPEN.cnf (ok), stop Timer_SYN;. And from the state 1110 to the state 4110 corresponds to transition 5450: T_CLOSE.req ( )/T_FIN (to:my_server), start Timer_FIN. It is also possible to arrive from a state 5120 at state 4110 according to 5300: T_SYN_ERR (from:my_server)/T_FIN (to:my_server) start Timer_FIN. From state 4110 to state 1130 according to transition 5550: T_FIN_ACK (from:my_server)/T_{—}CLOSE.cnf ( ) stop Timer_FIN, transition 5550: T_FIN (from:my_server)/T_FIN_ACK (to:my_server), T_CLOSE.cnf ( ) stop Timer_FIN. From state 1110 to state 5420 according to transition 5460: T_FIN (from:my_client)/T_CLOSE.ind ( ). From state 5420 to state 1130 according to transition 5660: T_CLOSE.rsp( )/T_FIN_ACK (to:my_client).

In case of transition 5100: T_FIN_ACK (from:any_server)/-, transition 5100: T_FIN (from:any_server)/T_FIN_ACK (to:any_client); transition 5200: T_FIN_ACK (from:any_server)/-, transition 5200: T_FIN (from:any_server)/T_FIN_ACK (to:any_client), transition 5200: timeout Timer_SYN/T_SYN (to:my_server), restart Timer_SYN; transition 5400: T_DATA.req/T_DATA (to:my_server) transition 5400: T_DATA (from:my_server)/T_DATA.ind transition 5400: T_FIN_ACK (from:other_server)/-, transition 5400: T_FIN (from:other_server)/T_FIN_ACK (to:other_client), transition 5400: T_SYN_ACK (from:my_server)/T_ACK_ACK (to:my_server); and transition 5500: T_SYN_ACK (from:my_server)/T_FIN (to:my_server), transition 5500: T_SYN_ERR (from:my_server)/T_FIN (to:my_server), transition 5500: T_FIN_ACK (from:other_server)/-, transition 5500: T_FIN (from:other_server)/T_FIN_ACK (to:other_client), transition 5500: timeout Timer_FIN/T_FIN (to:my_server), restart Timer_FIN; transition 5650: T_FIN_ACK (from:other_server)/-, and transition 5650: T_FIN (from:other_server)/T_FIN_ACK (to:other_client), the respective states 1130, 5120, 1110 and 4110 are maintained, respectively.

If in case of the state 5120 a second type of message 1150 respectively an error message is received they are responded with a third type of message 1170. In this case the second client timer is restarted. Both client timers in this case e.g. are mutually exclusive and therefore may be implemented as a single timer taking the function of both.

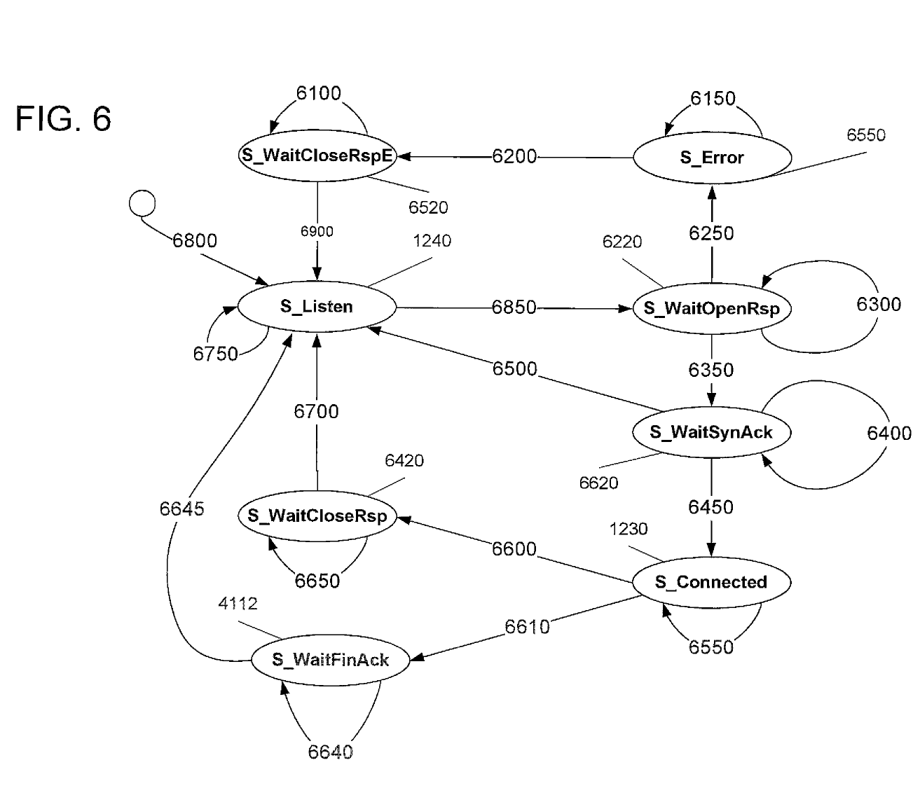

FIG. 6 shows a state machine depicting examples of states and transitions between states of a server 1200 in a communication situation of an unreliable network as shown in FIG. 4.

Here in comparison to the situation of a server making use of a reliable network it also receives the fourth type of message 4150 as an acknowledgement from the client 1100. As well it issues a sixth type of message 4170.

In the diagram of FIG. 6 a state 6520 “S_WaitCloseRspE” is shown accompanied by a state 6550 “S_Error” and a state 1240 “S_Listen” as well as a state 6220 “S_WaitOpenRsp” and a state 6620 “S_WaitSynAck”. Also shown are the state 1230 “S_Connected”, the state 6420 “S_WaitCloseRsp” and state 4112 “S_WaitFinAck”.

The state 1240 is initiated by, 6800: T_LISTEN.req/-; and is maintained in case of 6750: T_FIN (from:any_client)/T_{—}FIN_ACK (to:any_client), or 6750: T_FIN_ACK(from:any_client)/-. A transition from there according to 6850: T_SYN (from:my_client)/T_OPEN.ind (my_client), start Timer_Rsp; to the state 6220 takes place, which is maintained in case of 6300: T_FIN (from:other_client)/T_FIN_ACK (to:other_client), or 6300: T_FIN_ACK(from:other_client)/-. From there the state 6550 may be reached in case of 6250: timeout Timer_Rsp/stop Timer_Rsp, T_SYN_ERR (to:my_client); and is maintained corresponding to 6150: T_SYN (from:any_client)/T_SYN_ERR (to:any_client), 6150: T_FIN (from:any_client)/T_FIN_ACK (to:any_client), or 6150: T_FIN_ACK(from:any_client)/-. From this state 6550 the state 6520 can be reached by 6200: T_OPEN.rsp ( )/T_CLOSE.ind ( ) which is maintained according to 6100: T_SYN (from:any_client)/T_SYN_ERR (to:any_client), 6100: T_FIN (from:any_client)/T_FIN_ACK (to:any_client), or 6100: T_FIN_ACK(from:any_client)/-.

Another transition from the state 6220 to the state 6620 takes place corresponding to 6350: T_OPEN.rsp ( )/stop Timer_Rsp, T_SYN_ACK (to:my_client), start Timer_ACK;. The respective state is maintained corresponding to transition 6400: T_SYN (from:my_client)/T_SYN_ACK (to:my_client), transition 6400: T_SYN (from:other_client)/T_SYN_ERR (to:other_client), transition 6400: T_FIN (from:other_client)/T_FIN_ACK (to:other_client), transition 6400: T_FIN_ACK(from:other_client)/-, or transition 6400: timeout Timer_ACK/T_SYN_ACK (to:my_client), restart Timer_ACK; and from there according to 6450: T_ACK_ACK (from:my_client)/stop Timer_ACK, or 6450: T_DATA (from:my_client, data)/stop Timer_ACK, T_DATA.ind (data); the state 1230 is reached, which is maintained by transaction 6550: T_DATA.req (data)/T_DATA (to:my_client, data), transaction 6550: T_DATA (from:my_client, data)/T_DATA.ind (data), transaction 6550: T_SYN_ACK (from:other_client)/-, transaction 6550: T_SYN (from:other_client)/T_SYN_ERR (to:other_client), transaction 6550: T_FIN (from:other_client)/T_FIN_ACK (to:other_client), or transition 6550: T_FIN_ACK(from:other_client)/-. From there the state 6420 is adopted corresponding to 6600: T_FIN (from:my_client)/T_CLOSE.ind ( ); and will be maintained according to transition 6650: T_DATA.req (data)/T_DATA (to:my_client, data), transition 6650: T_FIN (from:my_client)/-, transition 6650: T_SYN (from:other_client)/T_SYN_ERR (to:other_client), transition 6650: T_FIN (from:other_client)/T_FIN_ACK (to:other_client), or transition 6650: T_FIN_ACK(from:other_client)/-. This state then may be left by a transition to the initial state 1240 corresponding to 6700: T_CLOSE.rsp/T_FIN_ACK (to:my_client); occurring.

The transition from state 6550 to state 6640 corresponds to 6610: T_CLOSE.req ( )/T_FIN (to:my_client), start Timer_FIN. The transition from state 6540 to state 1240 corresponds to 6645: T_FIN_ACK (from:my_client)/T_CLOSE.cnf ( ) stop Timer_FIN and 6645: T_FIN (from:my_client)/T_FIN_ACK (toLmy_client), T_CLOSE.cnf ( ), stop Timer_FIN. State 4112 will be maintained according to transition 6640: T_ACK_ACK (from:my_client)/T_FIN (to:my_client), transition 6640: T_SYN (from:other_client)/T_SYN_ERR (to:other_client), transition 6640: T_FIN (from:other_client)/T_FIN_ACK (to:other_client), transition 6640: T_FIN_ACK(from:other_client)/-, timeout Timer_FIN/T_FIN(to:my_client), restart Timer_FIN, or T_DATA (from:my_client, data)/-.

Another transition from the state 6220 to the state 1240 takes place corresponding to 6500: T_FIN (from:my_client)/T_FIN_ACK (to:my_client).

The term “my_client” identifies the application client whereas the term “my_server” identifies the application server in the drawings.

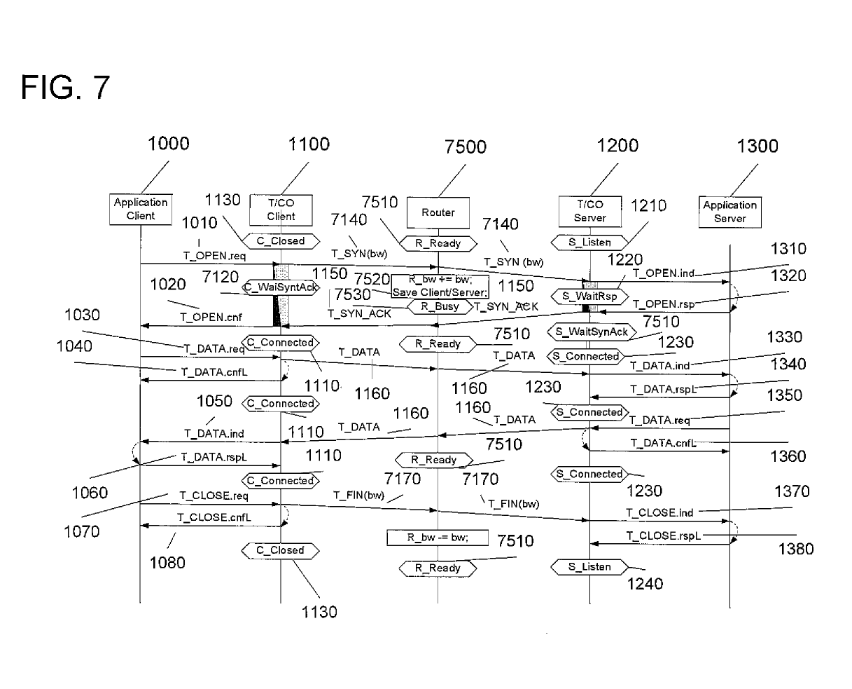

FIG. 7 shows an example of an embodiment of a method according to the present disclosure where the messages exchanged between client and server are forwarded by a router. This method advantageously applies bandwidth reservation for the connection and verification of available bandwidth before establishment of a connection. The main difference between this message chart and the chart showing the message flow depicting the connection management in a reliable network in FIG. 4 is that, if a router is present between the client 1100 and the server 1200, the router forwards messages that in FIG. 4 are exchanged between the client 1100 and the server 1200 and advantageously performs a bandwidth allocation respectively a bandwidth evaluation checking the availability of the bandwidth requested for the respective connection. In particular here the router 7500 is new and taking its respective states 7510 “R_Ready” as well as 7530 “R_Busy”. Furthermore the message format of the first type of message in comparison to the one explained in the previous drawings contains a bandwidth request and therefore is identified by reference numeral 7140 “T_SYN(bw)”. Also the message format of the third type of message now preferably contains a bandwidth request and therefore is identified by different reference numeral 7170 “T_FIN(bw)”. The router 7500 between the client 1000 and the server 1100 here uses for instance a bandwidth parameter or a plurality of bandwidth parameters to evaluate if the requested bandwidth fits the link capacity given that some of the link bandwidth may already be reserved for other connections if the bandwidth reservation succeeds, the router forwards the first type of message otherwise for instance it generates an error communicated either to the client 1000 or the server 1100. Furthermore advantageously the router also enters the state 7530 indicating that the router is busy in which it does not accept another bandwidth reservation request for another connection. Once the router identifies the second type of message being a confirmation from the server 1100 transmitted to the client 1000 for the same pair of client and server which confirms, that all the involved routers have successfully reserved the requested bandwidth it moves back to a ready state 7510. The “R_Busy” state 7530 is for instance needed to filter out any possible retransmissions of the first type of message 7140 and advantageously prevents double updates of the bandwidth reservation at the router. Furthermore in comparison to the previous drawings the connection is terminated by the third type of message 7170 here containing the same bandwidth parameter(s) as the first type of message 7140 which have been for instance saved at the client 1000 and server 1100 which issues third type of message 7170. As a consequence of receiving the third type of message 7170 the router 7500 decrements its reserved bandwidth. If message exchange takes place on the basis of a reliable network this operation can never fail and therefore a third type of message 7170 can not be lost and therefore in this case preferably no timer is needed to follow up on the proper handling of this message. The evaluation process and the storage process at the router is indicated by the box 7520.

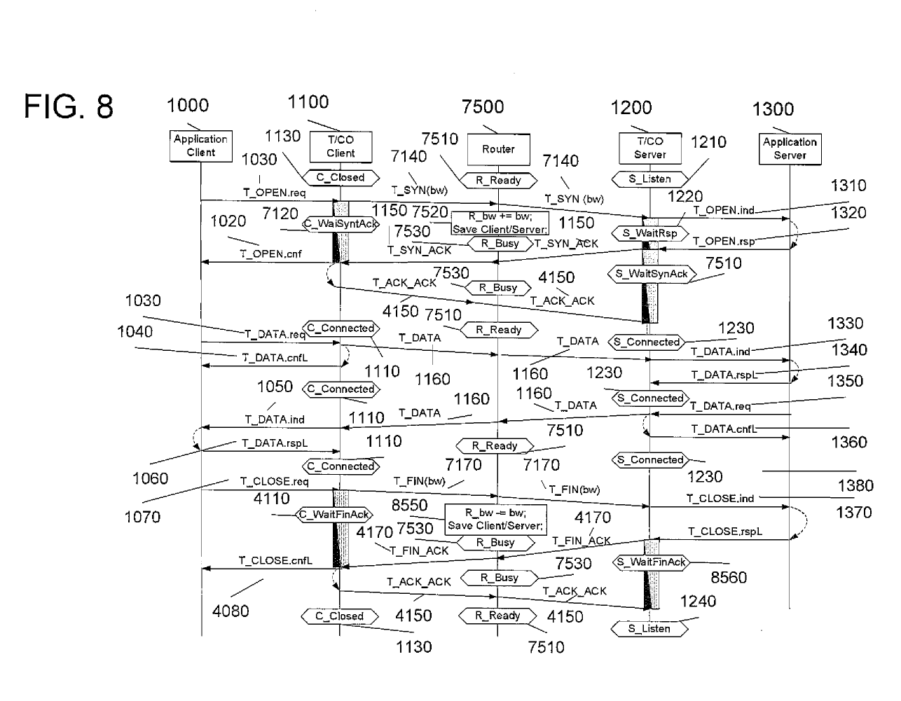

FIG. 8 gives another example of a message flow of an embodiment of a method according to the present disclosure where the message exchange is taking place on an unreliable network, respectively on a network supporting traffic classes for real-time communication.

In comparison to the message flow shown in FIG. 4 this message flow includes also like the previous message flow a router 7500 for forwarding the messages exchanged between client 1000 and a server 1100. As previously explained, when elaborating on the message flow at FIG. 4 supporting an unreliable network preferably requires closer supervision of the messages exchanged between client 1000 and server 1100 and also precautions at the router 7500.

Here also a fourth type of message 4150 is required during the cause of terminating the connection. The reason lies in the requirement of any router update needing three messages one message initializing the communication carrying the bandwidth like the first type of message 7140 and the third type of message 7170, a second message acknowledging the first type of message like message 1150 and message 8150 “T_FIN_ACK” and a third message to commit the bandwidth change like message 4150. In this case the router 7500 changes its state to 7530 indicating “R_Busy” in case the router is busy or can not honour the bandwidth change in case of insufficient free bandwidth the router generates an “S_Error” message as will be explained further below. The bandwidth allocation and evaluation is here further indicated by box 8550 at the router 7500.

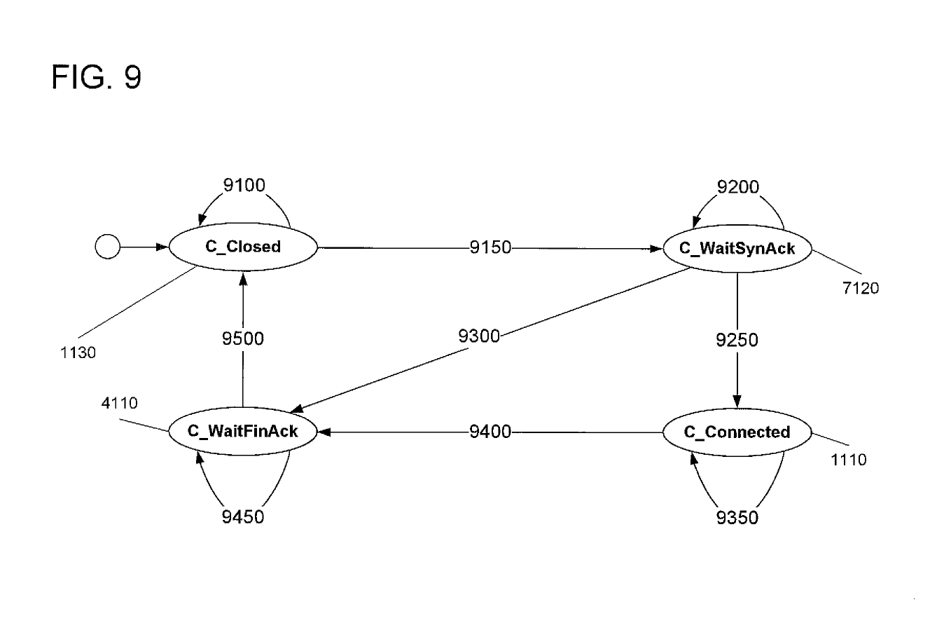

FIG. 9 indicates the states and state transitions as an example of a state machine associated to the message flow in FIG. 7 observed from a client side.

Here following states are possible 7120, 1110, 4110 and 1130.

A state transition from state 1130 to state 7120 takes place corresponding to 9150: T_OPEN.req (my_server, bw)/conn_bw=bw, T_SYN (to:my_server, bw), start Timer_SYN; whereas a state transition from state 7120 to state 4110 is possible corresponding to 9300: T_SYN_ERR (from:my_server)/T_FIN (to:my_server, conn_bw). On the other hand a state transition from state 7120 to state 1110 for the client takes place according to 9250: T_SYN_ACK (from:my_server)/T_ACK_ACK (to:my_server), T_OPEN.cnf (ok), stop Timer_SYN. A further transition possibility between state 1110 and state 4110 exists in corresponding to 9400: T_CLOSE.req ( )/T_FIN (to:my_server, conn_bw), start Timer_FIN. In the case of transition 9100: T_FIN_ACK (from:any_server)/T_ACK_ACK (to:any_server); transition 9200: T_FIN_ACK (from:any_server)/T_ACK_ACK (to:any_server), transition 9200: timeout Timer_SYN/T_SYN (to:my_server, conn_bw), restart Timer_SYN; transition 9350: T_DATA.req/T_DATA (to:my_server), transition 9350: T_DATA (from:my_server)/T_DATA.ind, transition 9350: T_FIN_ACK (from:other_server)/T_ACK_ACK (to:other_server), transition 9350: T_SYN_ACK (from:my_server)/T_ACK_ACK (to:my_server); and transition 9450: T_SYN_ACK (from:my_server)/T_FIN (to:my_server, bw), transition 9450: T_SYN_NAC (from:my_server)/T_FIN (to:my_server, bw), transition 9450: T_FIN_ACK (from:other_server)/T_ACK_ACK (to:other_server), transition 9450: timeout Timer_FIN/T_FIN (to:my_server, conn_bw), restart Timer_FIN; the respective states (1130, 7120, 9350 and 9450, respectively) are maintained.

Here when bandwidth reservation is added to the connection management, preferably the necessary bandwidth requirement is given as a parameter to the message 1010. For instance, the bandwidth may be expressed in raw bandwidth instead of the alternative e.g. a link usage percentage, and may for instance contain a different value for each direction client to server and reverse server to client. Also more elaborated bandwidth description are possible. For instance, a dedicated bandwidth, for which a hard guarantee is provided, and a shared bandwidth for which only a soft guarantee is provided. This bandwidth or a set of bandwidth parameters is also added to the first type of message 7140 and the third type of message 7170. The bandwidth is for instance saved as a connection bandwidth when the message 1010 is received and then used for both the first type of message 7140 and the third type of message 7170. A fourth type of message 4150 ensures the correct bandwidth update at the routers 7500. As an improvement, if the bandwidth parameter of the third type of message 7170 is 0, the fourth type of message 4150 can be omitted.

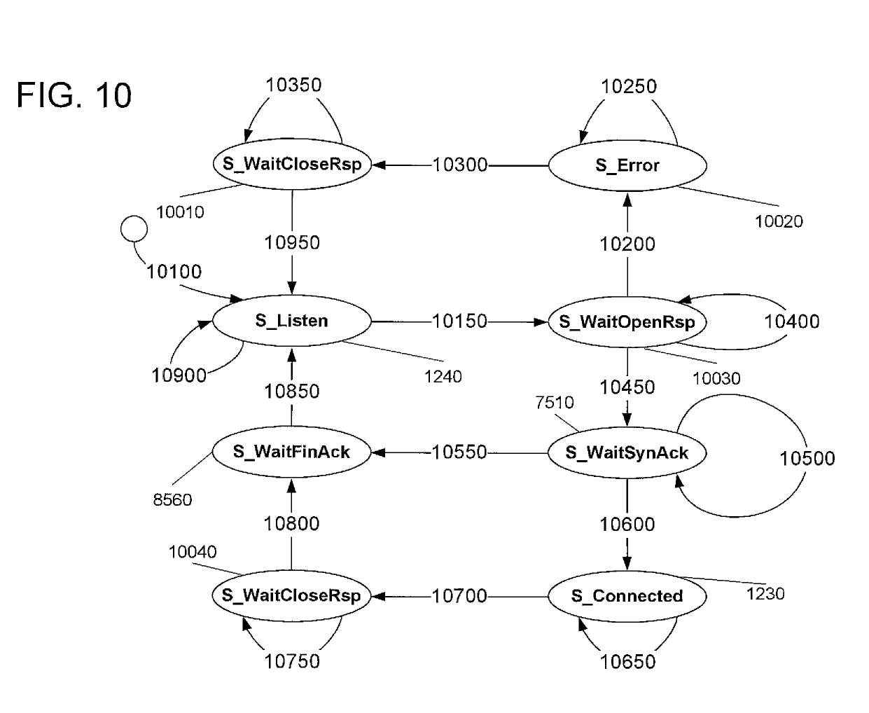

FIG. 10 shows an example of a state machine indicating states and state transitions a server can take in an embodiment of a method according to the present disclosure that is explained in a message flow in FIG. 8.

The state machine has the following states and state transitions: 10010 “S_WaitCloseRsp”; 10020 “S_Error”; 1240; 10030 “S_WaitOpenRsp”; 7510; 8560; 1230 and 10040 “S_WaitCloseRsp”.

State 1240 is initiated by 10100: T_LISTEN.req/-; and a transition to state 10030 occurs corresponding to 10150: T_SYN (from:my_client, bw)/T_OPEN.ind (my_client), start Timer_Rsp. A transition from state 10030 to state 10020 occurs by 10200: timeout Timer_Rsp/stop Timer_Rsp, T_SYN_ERR (to:my_client); and from there to state 10010 corresponding to 10300: T_OPEN.rsp ( )/T_CLOSE.ind ( ); occur.

Furthermore a state transition between state 10030 and state 7510 occurs corresponding to 10450: T_OPEN.rsp ( )/stop Timer_Rsp, T_SYN_ACK (to:my_client), start Timer_ACK.

Furthermore from there a transition is possible to state 1230 corresponding to transition 10600: T_ACK_ACK (from:my_client)/stop Timer_ACK, transition 10600: T_DATA (from:my_client, data)/stop Timer_ACK, T_DATA.ind (data); and from state 7510 to state 8560 according to 10550: T_FIN (from:my_client, bw)/T_FIN_ACK (to:my_client), start Timer_ACK. Furthermore a state transition from state 1230 to state 10040 takes place by 10700: T_FIN (from:my_client, bw)/T_CLOSE.ind ( ). From there a further state transition to state 8560 is possible corresponding to 10800: T_CLOSE.rsp/T_FIN_ACK (to:my_client), start Timer_ACK; and back to the starting point from state 8560 to state 1240 a transition is possible according 10850: T_ACK_ACK (from:my_client)/stop Timer_ACK.

The respective states (10010, 10020, 1240, 10030, 7510, 1230 and 10040, respectively) are maintained corresponding to transition 10350: T_SYN (from:any_client, bw)/T_SYN_ERR (to:any_client), transition 10350: T_ACK_ACK (from:any_client)/-; transition 10250: T_SYN (from:any_client, bw)/T_SYN_ERR (to:any_client), transition 10250: T_ACK_ACK (from:other_client)-; transition 10900: T_ACK_ACK (from:any_client)-; transition 10400: T_ACK_ACK (from:other_client)-; transition 10500: T_SYN (from:my_client, bw)/T_SYN_ACK (to:my_client), transition 10500: T_SYN (from:other_client, bw) T_SYN_ERR (to:other_client), transition 10500: T_ACK_ACK (from:other_client)/-, transition 10500: timeout Timer_ACK/T_SYN_ACK (to:my_client), restart Timer_ACK; transition 10650: T_DATA.req (data)/T_DATA (to:my_client, data), transition 10650: T_DATA (from:my_client, data)/T_DATA.ind (data), transition 10650: T_SYN_ACK (from:other_client)/-, transition 10650: T_SYN (from:other_client, bw)/T_SYN_ERR (to:other_client), transition 10650: T_ACK_ACK (from:other_client)/-; and transition 10750: T_DATA.req (data)/T_DATA (to:my_client, data), transition 10750: T_FIN (from:my_client, bw)/-; transition 10750: T_SYN (from:other_client, bw)/T_SYN_ERR (to:other_client); transition 10750: T_ACK_ACK (from:other_client)/-. Also from state 10010 a transition to state 1240 occurs according to 10950: T_CLOSE.rsp/-.

Furthermore the server e.g. also receives the bandwidth parameters on the first type of message 7140 and the third type of message 7170. The state 8560 is introduced in order to preferably cause the server to wait on the fourth type of message 4150. The sixth type of message 4170 is also preferably protected in its secured transmission by a timer which is started when the sixth type of message 4170 is transmitted and triggers a retransmission if the timer expires. All the timers at the server can be implemented preferably and advantageously in one timer, as they do not run in parallel.

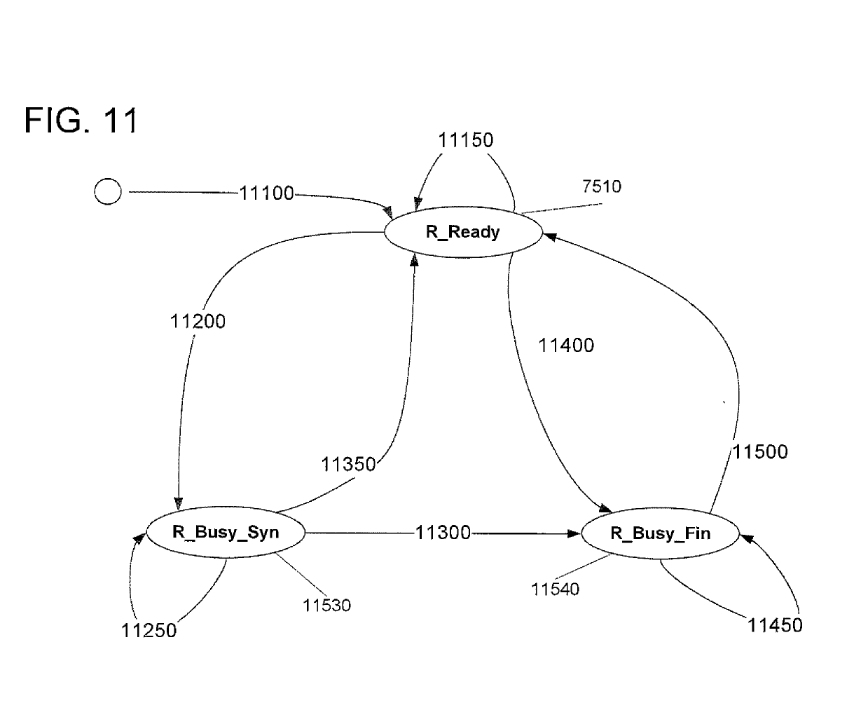

FIG. 11 shows an example of a state machine for states and state transitions a router can adopt in the embodiment of the method according to the present disclosure shown and explained in FIG. 8.

Following states are e.g. possible: 7510; 11540 “R_Busy_Fin” and 11530 “R_Busy_Syn”.

An initiation of state 7510 takes place according to 11100: R_bw=0, err_flag=false. From there state transition to the state 11540 takes place corresponding to 11400: T_FIN (from:client, to:server, bw)/R_client=client, R_server=server, R_bw−=bw, T_FIN (from:client, to:server, bw). Back from state 11540 a transition is possible corresponding to 11500: T_ACK_ACK (from:R_client, to:R_server)/err_flag=false, T_ACK_ACK (from:R_client, to:R_server); occurring. A state transition from state 7510 to state 11530 can also take place corresponding to transition 11200: T_SYN (from:client, to:server, bw), (R_bw+bw)≦MAX_BW/R_client=client, R_server=server, R_bw+=bw, T_SYN (from:client, to:server, bw), or transition 11200: T_SYN (from:client, to:server, bw), (R_bw+bw)>MAX_BW/R_client=client, R_server=server, err_flag=true, T_SYN_ERR (from:client, to:server); and from there back to the starting point corresponding to 11350: T_ACK_ACK (from:R_client, to:R_server)/err_flag=false, T_ACK_ACK (from:R_client, to:R_server). Another state transition between state 11530 and 11540 takes place corresponding to 11300: T_FIN (from:client, to:server, bw)/T_FIN (from:client, to:server, bw).

The respective states (7510, 11540 and 11530, respectively) are maintained according to transition 11150: T_DATA (from:node1, to:node2)/T_DATA (from:node1, to:node2), transition 11150: OTHER_MSG (from:node1, to:node2, . . . )/OTHER_MSG (from:node1, to:node2, . . . ); transition 11450: T_FIN_ACK (from:R_server, to:R_client)/T_FIN_ACK (from:R_server, to:R_client), transition 11450: T_FIN (from:R_client, to:R_server, bw)/T_FIN (from:R_client, to:R_server, bw), transition 11450: T_FIN (from:other_client, to:other_server, bw)/-, transition 11450: T_DATA (from:node1, to:node2)/T_DATA (from:node1, to:node2), or transition 11450: OTHER_MSG (from:node1, to:node2, . . . )/OTHER_MSG (from:node1, to:node2, . . . ); and transition 11250: T_SYN_ACK (from:server, to:client)/T_SYN_ACK (from:server, to:client), transition 11250: T_SYN_ERR (from:server, to:client)/T_SYN_ERR (from:server, to:client), transition 11250: T_SYN (from:R_client, to: R_server, bw) && (err_flag==false)/T_SYN (from:R_client, to:R_server, bw), transition 11250: T_SYN (from:R_client, to:R_server, bw) && (err_flag==true)/T_{—}SYN_ERR (from:R_client, to:R_server), transition 11250: T_SYN (from:other_client, to:other_server, bw)/-, transition 11250: T_DATA (from:node1, to:node2)/T_DATA (from:node1, to:node2), or transition 11250: OTHER_MSG (from:node1, to:node2,/OTHER MSG (from:node1, to:node2, . . . ).

For instance, the router has to build up states during the process of opening and closing the connection. The default state is 7510 where the router is ready and from where it forwards packets to their destinations. However, if the router receives a first type of message 7140 or a third type of message 7170 the router bandwidth reservation is preferably updating and in the course of doing this the router moves to the states 11530 and 11540 respectively. In case the router is in the initial state 7510 and receives a message 7140 having enough bandwidth for allocation it updates the bandwidth and forwards the message to the server. On the other hand if the bandwidth availability is insufficient the router issues an error_flag to prevent the bandwidth from being updated and an error message is set to the server instead of forwarding the message 7140. The error_flag preferably may be used to prevent the bandwidth from being updated when closing the connection. In both cases the client and server pair involved in the connection setup is preferably safe to prevent multiple bandwidth update due to retransmissions. Being in the state 7510 in case the router receives the message 7170 also the client server pair is safe as for the message 7140 and the router bandwidth is preferably increased with bw.

Being in the state 11530, if a fourth type of message 4150 is received matching the saved client server pair, the error_flag is cleared and the router moves to the state 7510. If a message 7170 is received matching the saved client server pair the router transits to the state 11540. Preferably all messages including the message 4150 and the message 4170 are forwarded. With the exception, that once a message 7140 is received for the client server pair that is saved and the error_flag is set. When being in the state 11540 if the message 4150 is received matching the saved client server pair, the error_flag is cleared and the router moves to the state 7510. In this state all messages including the message 4150 are forwarded. For every connection opening/closing, the router needs to preferably save a state identifying the connection referring to the client and server identities which may consist of address and port. For instance, the simplest router implementation may save a single connection identity as shown in FIG. 11. Alternatively, a router could store several connection identities, in which case it may employ one state machine as shown in FIG. 11 per connection identity it is able to save. In this case each time a message 7140 or 7170 is received which can be stored in a connection identity, the router engages in the states and state transitions shown in FIG. 11. In case the router is not able to store the connection identity, preferably the router discards the message 7140 respectively 7170 and takes no further action.

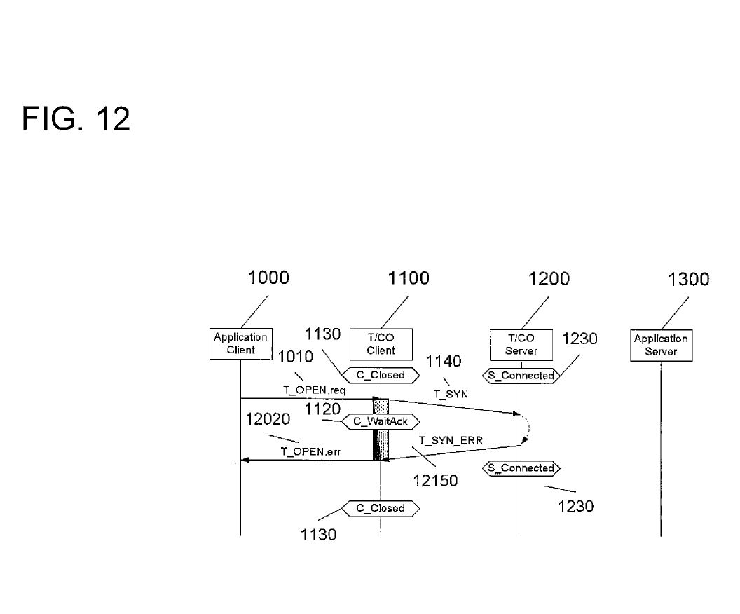

The following FIGS. 12 to 21 discuss various examples of errors and their handling according to the method of the discussed embodiments of the method of the present disclosure, which in the same manner may be handled by the system according to the present disclosure.

FIG. 12 gives an example of an error case potentially occurring in an embodiment of a method according to the present disclosure in further detail in FIG. 1.

In this case for instance the server 1200 may be busy and therefore not able to forward the first type of message 1140 because it is in the state 1230 indicating, that at present the server 1200 is dealing with a different connection. In this case instead of establishing a connection with the application server 1300 it generates an error message 12150 “T_SYN_ERR” which when received by the client 1100 causes the client to transit to the state 1130 where the connection is closed, instead of the state 1110, where the client would be connected.

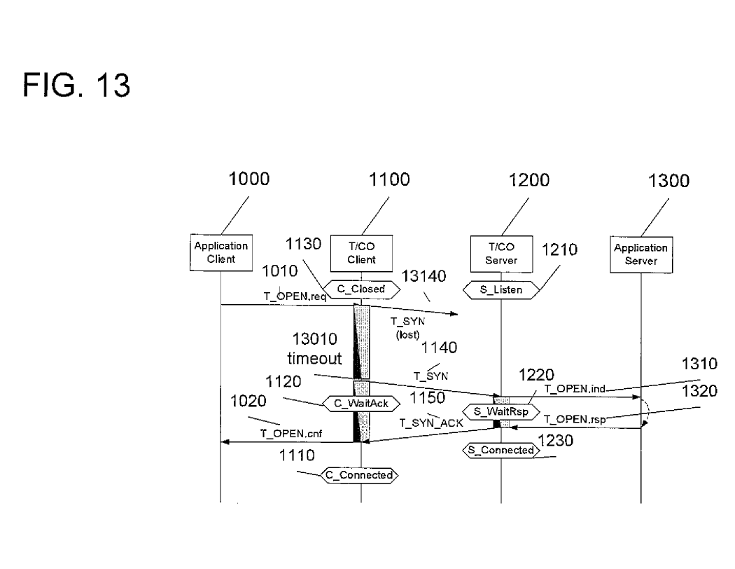

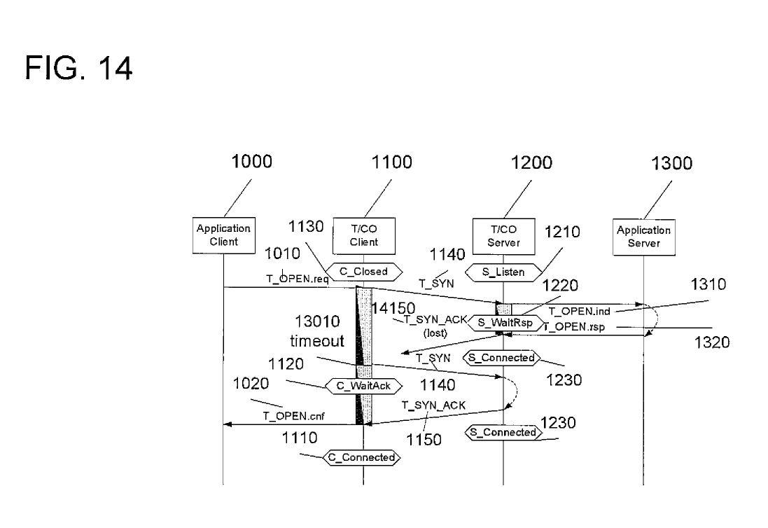

FIGS. 13 and 14 illustrate the use of a timer to supervise the transmission of a message which can potentially be lost or discarded.

FIG. 13 shows the case, where an error potentially might occur in an embodiment of a method according to the present disclosure which is discussed in more detail in FIG. 1. In this case the first type of message may be lost 13140 and therefore will not be received or processed by the server 1200 which remains in the state 1210. In this case however the first client timer measuring the first predefined time period expires causing a retransmission of the first type of message 1140 to establish the connection between the client 1100 and the server 1200. The first predefined time period is preferably dimensioned in such a manner, that it allows the server 1200 sufficient processing time to generate a second type of message 1150 as well as sufficient transmission time in both directions. The further handling is as discussed in FIG. 1, when the second type of message 1150 is received by the client 1100.

FIG. 14 explains another error and its handling that might potentially occur in an embodiment of a method according to the present disclosure discussed associated with FIG. 4 in more detail. In this case the second type of message indicated with reference sign 14150 is lost. Also in this case a timeout occurs indicated by reference sign 13010 as in FIG. 13 causing a retransmission of the first type of message 1140. This message arriving at the server 1200 is detected and due to the state transition caused by the first type of message 1140 received at the first time from state 1210 to 1220 this allows the server to identify that this message 1140 is retransmitted and the source of this message is the first. Allowing server to discard the retransmitted message 1140 without processing, and make a state transition to state 1230 where it is connected and to send a second type of message for confirmation 1150.

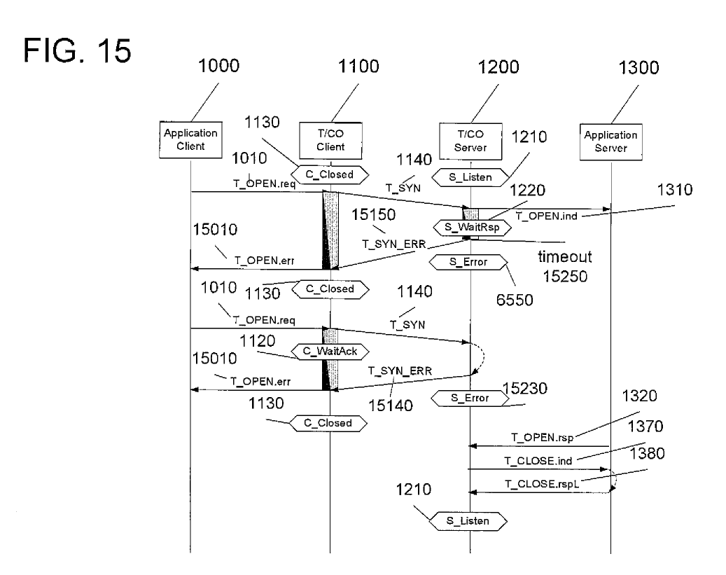

FIG. 15 explains an example of another error case that may occur in an embodiment of the method according to the present disclosure discussed in more detail in FIG. 1 in its message exchange. In this case it will be discussed what might occur in case the application at the application server 1300 crashes. Here although the server 1200 has sent a message 1310 it will not receive a response from the crashed application 1320. This leads to a timeout 15250 at the first server timer measuring a second predefined time period which in its dimensioning should take into account the message transfer in both directions and an amount of time for the application server to process the message 1310 and generate a response 1320. Expiration of the first server timer due to the timeout 15250 generates the states 6550 indicating an error, and sends an error message 15150 to the client. A further transmission of a first type of message 1140 will lead to an error message 15140 from the server 1200 and as corresponding message to the application client 15010 in response to error messages 15150 respectively 15140. In both cases the client will close the connection and move to state 1130.

If the application server responds to the server with a message 1320 T_OPEN.rsp, the server notifies the application server that the connection is actually closed using the message 1370 T_CLOSE.ind, and returns to state 1210 S_Listen, where the server is ready to receive connection setup requests.

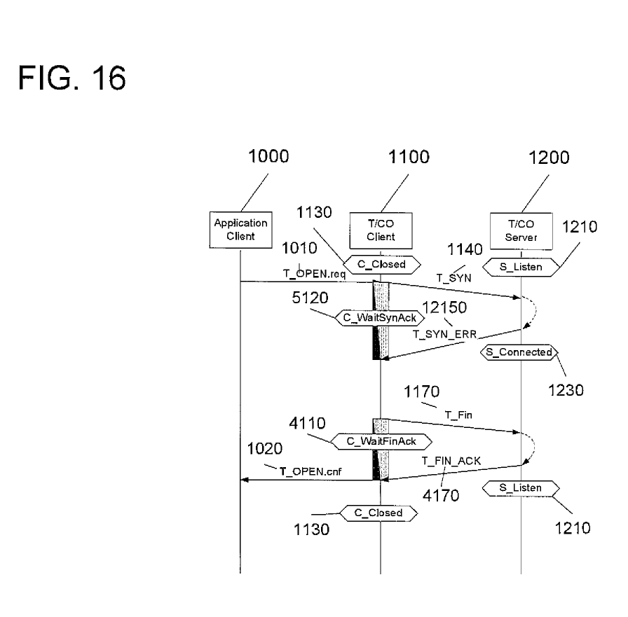

FIG. 16 gives an example how an error can be handled in an embodiment of a method according to the present disclosure discussed in its message flow in detail in FIG. 4.

Here also like previously discussed in the case for a reliable network the server 1100 is busy and can not establish a connection upon request. It consequently generates an error message 12150 to inform the client 1100. This causes a connection close operation at the client 1100 issuing a third type of message 1150 which is acknowledged by a sixth type of message 4170 issued from the server 1200. The client then moves to the state 1130.

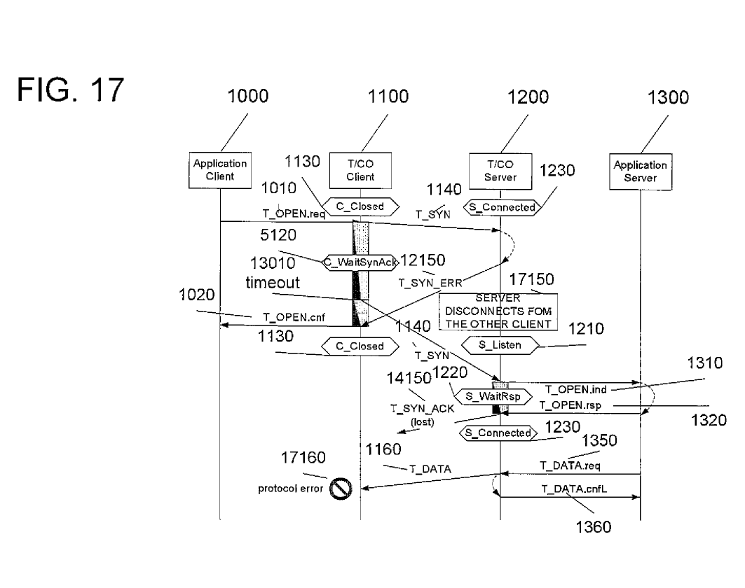

FIG. 17 discusses a potential error case occurring in an embodiment of the method according to the present disclosure where the message exchange is based on an unreliable network as discussed in more detail in FIG. 4. As in an unreliable network any message may be corrupted or lost also the second type of message 1150 should preferably be supervised for its proper handling. If this is not the case, the loss may lead to the server being left in an “S_Connected” state 1230 being at first busy while responding with an error message upon request to establish a connection 12150 then however disconnects from the other client indicated by reference sign 17150 and becomes available for a new connection again in the state 1210. The error message however arrives at the client 1100 too late and after the timeout 13010 that caused a retransmission of the first type of message 1140 which causes the server to open the connection with the application server 1300 and start the transmission of data 1160 which creates a protocol error 17160 as the second type of message 14150 was lost.

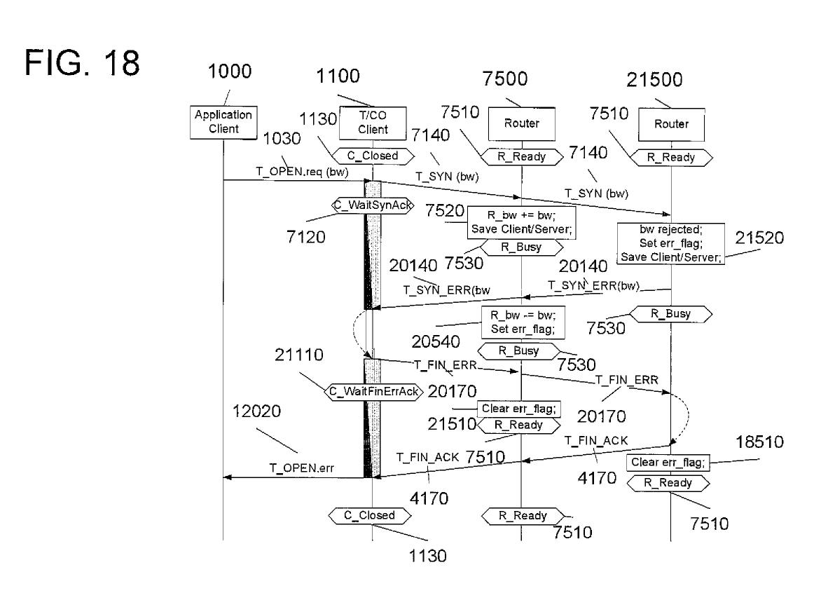

FIGS. 18 to 21 discuss different error cases that may occur in an embodiment of the method according to the present disclosure that in more detail is discussed and shown in FIG. 8 and the associated explanations.

There the router 7500 is busy or can not honour a bandwidth change request due to unavailability of bandwidth and generates an error message due to this situation.

FIG. 18 shows a first case handling of that situation. Receiving a first type of message 7140 a router 21500 rejects the bandwidth allocation and sets an error flag at 21520. This leads to the transmission of an error message 20140 to the router 7500 which is forwarded to the client 1100. The router 7500 sets an error flag at 20540. On the other hand the client receiving the error message 20540 starts terminating the connection sending the termination upon error message 20170 “T_FIN ERR”. Forwarded to the router 21500 this generates an acknowledge message 4170 which upon arrival at the client 1100 triggers the generation of an error message 12020 “T_OPEN.err”.

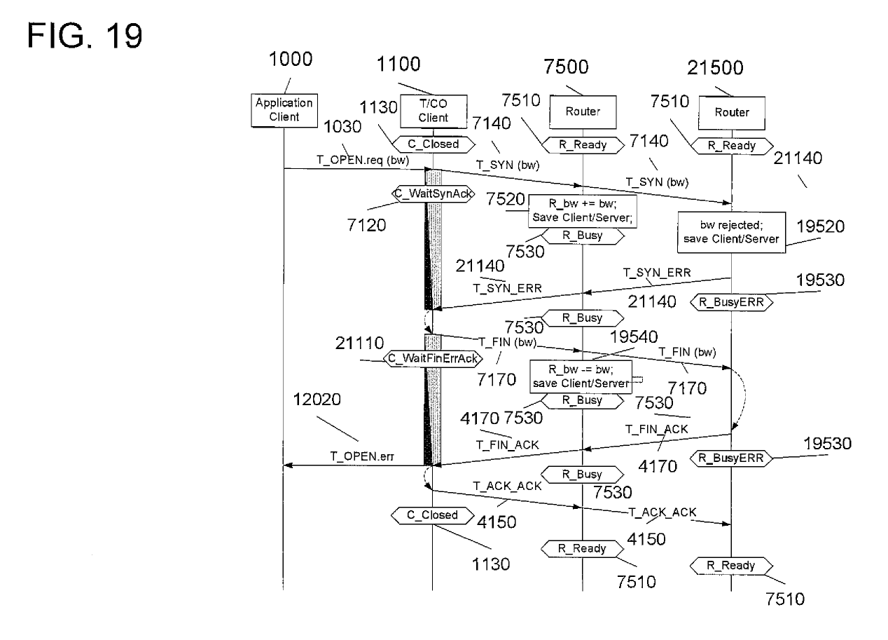

FIG. 19 gives an example of the same error case discussed in FIG. 18 with a slight change of the message flow and handling. Receiving the first type of message 7140 the router 21500 does not set an error_flag at 19520 and does not transmit bandwidth information at the error message 21140 to the client. Contrary to the previous example thus the client 1100 can follow up with a normal connection termination as discussed in FIG. 8.

In this case the router enters a different state in the error case 19530 “R_BusyERR”. The normal connection termination will also free the bandwidth allocation where available. In the case of the example given in FIG. 19 the message handling is easier and requires a lower amount of messages to be transmitted. In both cases however shown in FIGS. 18 and 19 the router preferably needs to be adapted to implement some functionality of the server when issuing error messages 21140 and 20140.

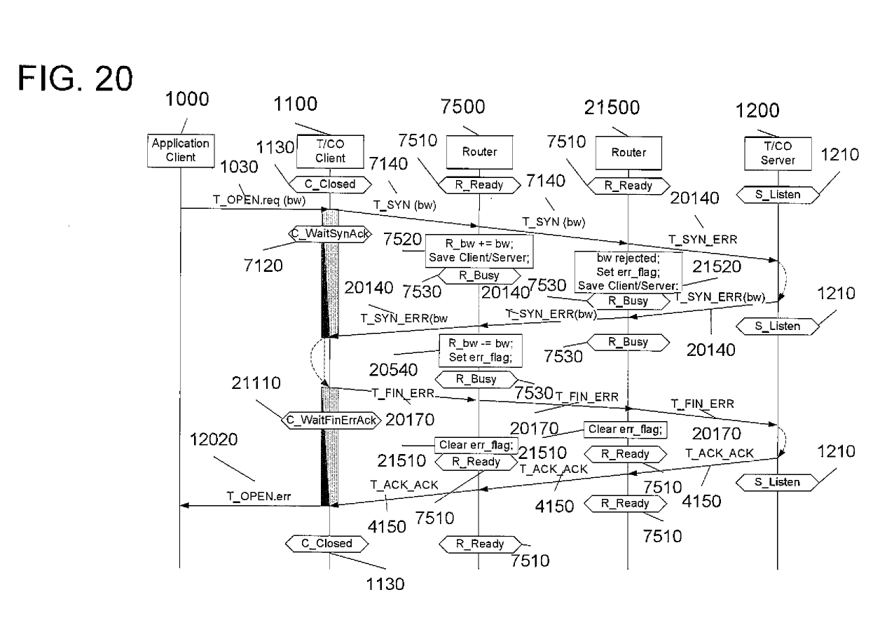

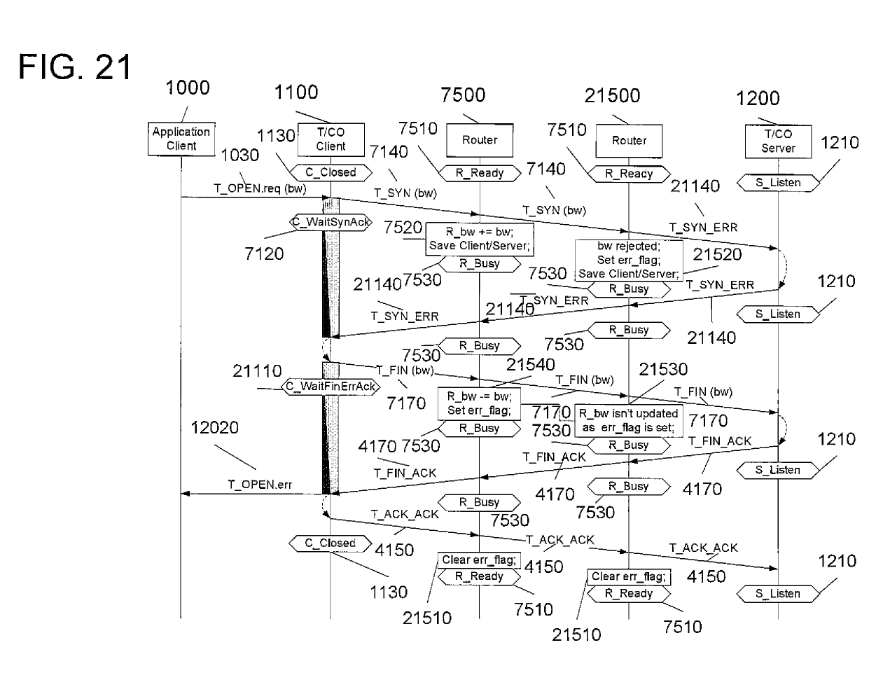

In order to avoid such a modification of the router, a potential alternative is to forward the error handling to the server 1200 which is discussed in the examples in FIG. 20 and FIG. 21.

FIG. 20 gives an example of the handling of an error case where the router is busy and the message exchange is based on an unreliable network in an embodiment of a method according to the present disclosure discussed in FIG. 8.

Here similar to the case discussed in FIG. 18 once receiving a forwarded first type of message 7140 and having no available bandwidth, the router sets an error_flag and forwards new in this case the error message 20140 to the server 1200 which generates an error message 20140 including a bandwidth parameter. A further additional task by the server is to respond to the connection termination upon error issued by the client 1100 by a seventh type of message 4150.

FIG. 21 also gives an example of the error handling discussed in association to FIG. 19, in this case however the error handling is taking place at the server 1200. As a modification the protocol in FIG. 19 is modified in such a manner, that the error message 21140 is forwarded to the server 1200 which will then be responsible to send the error message 21140 and to handle the termination of the connection.

For an unreliable network, potential alternatives for updating the bandwidth in the router is to do it with the second type of message 1150 instead of 7140 and/or message 4170 instead of 7170. Here the client/server pair may be saved as before as well as the flag ERR_flag may be set, when the first message 7140 and/or 7170 is received. In this case however the bandwidth parameter will be carried by the messages 1150 and 4170. In this case of an error, the error message 21140 does not carry any bandwidth parameter and will lead to a connection termination with no bandwidth, because no bandwidth updates were made by messages 1150 and/or 4170. Thus the message 4150 can be optimized further in this error case.

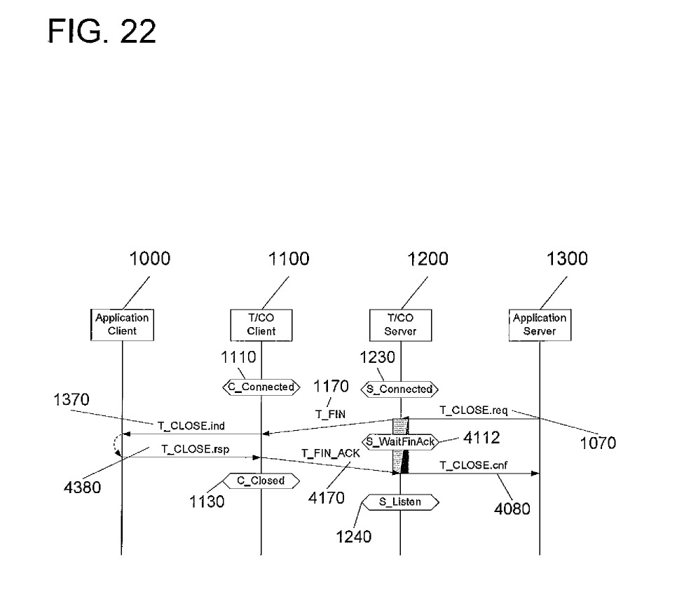

FIG. 22 further to FIG. 4 in a similar context showing a case in which the connection is closed by the Application Client 1000 which is sending a message 1070 “T_CLOSE.req” exemplifies a different option. Alternatively, the connection may also be closed by the Application Server 1300 which sends a message 1070 “T_CLOSE.req”. Also in this case, the resulting steps are the same. The T/CO Server 1200, when receiving message 1070 “T_CLOSE.req” sends message 1170 “T_FIN”, starts a timer and enters state 4112 “S_WaitFinAck”. When the T/CO Client 1100 receives message 1170 “T_FIN”, it issues message 1370 “T_CLOSE.ind” to the Application Client, which responds with message 4380 “T_CLOSE.rsp” to the T/CO Client 1100, which in turn sends message 4170 “T_FIN_ACK” to the T/CO Server and enters state 1130 “C_Closed”. When it receives message 4170 “T_FIN_ACK”, the T/CO Server stops its timer, sends message 4080 “T_CLOSE.cnf” to the Application Server 1300, and enters state 1240 “S_Listen”.

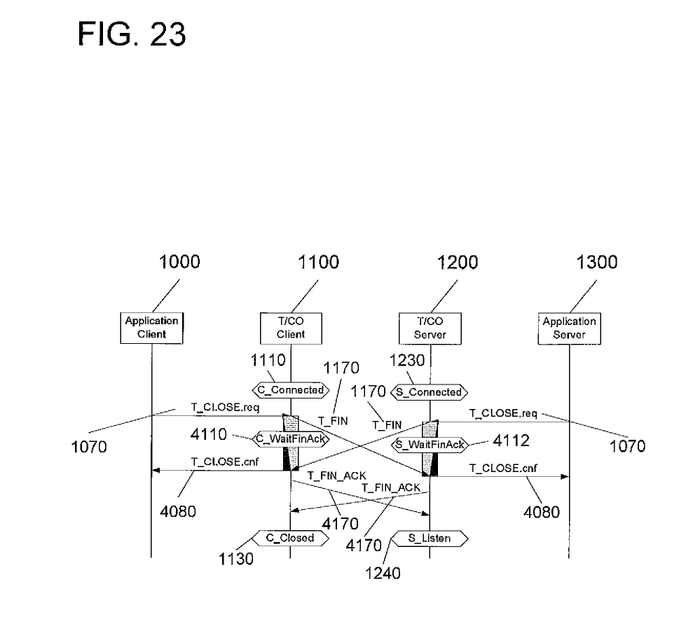

FIG. 23 further to FIG. 4 in a similar context illustrates a case in which a connection closing is simultaneously requested at both T/CO Client 1100 and T/CO Server 1200. In this case, messages 1070 “T_FIN” from the T/CO Client 1100 and T/CO Server 1200 cross over in the network. When message 1070 “T_FIN” is received at the T/CO Client 1100, the T/CO Client 1100 stops the timer, sends message 4170 “T_FIN_ACK” to the T/CO Server 1200, and moves to state 1130 “C_Closed”. When message 1070 “T_FIN” is received at the T/CO Server 1200, the T/CO Server 1200 stops the timer, sends message 4170 “T_FIN_ACK” to the T/CO Client 1100, and moves to state 1240 “S_Listen”.

The present disclosure also includes that any of the functionality of the system such as embodied in the server and/or client may be implemented as hardware, computer software, or combinations of both. The system, e.g. the client and/or server may include a general purpose processor, a digital signal processor (DSP), an application specific integrated circuit (ASIC), a field programmable gate array (FPGA) or other programmable logic device, discrete gate or transistor logic, discrete hardware components, or any combination designed to perform the functions described herein. A general purpose processor may be a microprocessor or state machine. A processor may also be implemented as a combination of computing devices, e.g., a combination of a DSP and a microprocessor, a plurality of microprocessors, one or more microprocessors in conjunction with a DSP core, or any other such configuration. The processor used in the client and/or server is adapted to carry out any method of the disclosure.

The present disclosure also includes a computer program product comprising code segments adapted for execution on any type of computing device, e.g. for use in a server and/or client, i.e. one including a processing engine. Software code in the computer program product, when executed on a computing device provides in a client the functionality of requesting establishment of a connection by sending a first type of message to a server. In the server the software when executed on a computing device confirms the ability of establishing the connection by sending to the client a second type of message leading to the server being connected. The software is preferably arranged such that sending the first type of message starts a first client timer measuring a first predefined time period as a first maximum response time and is preferably arranged such that on receipt of the second type of message or a data message the first client timer is stopped. The software is preferably also arranged such that the connection is closed by sending a third type of message.

The software is preferably also arranged such that if the first predefined time period expires, without a second type of message being received, another first type of message is sent. The software is preferably also arranged such that the server returns an error message if the server cannot accept a connection.

The software is preferably also arranged such that:

a) receiving the second type of message leads to the client being connected; and

b) the client sends a fourth type of message to the server to confirm the reception of the second type of message.

The software is preferably also arranged such that sending of the second type of message starts a first server timer measuring a second predefined time period as a second maximum response time and receiving the fourth type of message stops the first server timer.

The software is preferably also arranged such that in case the server is not able to establish a connection it sends a fifth type of message to the client leading to the client being not connected.

The software is preferably also arranged such that sending the third type of message starts a second client timer measuring a third predefined time period as third maximum response time.

The software is preferably also arranged such that the server confirms the reception of the third type of message by sending a sixth type of message.

The software is preferably also arranged such that sending of the sixth type of message starts a second server timer measuring a fourth predefined time period as fourth maximum response time.

The software is preferably also arranged such that receiving the sixth type of message at the client stops the second client timer; and causes the client to send a fourth type of message.

The software is preferably also arranged such that sending the third type of message by the server starts a second server timer measuring a third predefined time period as third maximum response time.

The software is preferably also arranged such that the client receiving the third type message confirms the reception of the third type of message by sending a sixth type of message.

The software is preferably also arranged such that sending of the sixth type of message starts a second client timer measuring a fourth predefined time period as fourth maximum response time.

The software is preferably also arranged such that receiving the sixth type of message at the server stops the second server timer; and causes the client to send a fourth type of message.

The software is preferably also arranged such that at least one of the messages between the client and the server can pass through a router, wherein the at least one message contains a request for resource reservation; and the router only forwards the at least one message in case it is able to provide the requested resource.

The software is preferably also arranged such that if the router forwards the at least one message it suspends further resource reservation requests until it receives a second type of message associated to the client server pair involved in establishing the connection associated to the request for resource reservation.

The software is preferably also arranged such that at least one message is used to cancel the resource reservation in case the connection is closed.

The software is preferably also arranged such that the client and the server respectively establish the connection between a respective application client and a respective application server.

The present disclosure also includes a non-transitory machine readable signal storage medium storing the computer program product described above. For example the non-transitory machine readable signal storage medium may be an optical disk such as a CDROM a DVDROM, or a magnetic tape memory, a magnetic disk memory such as a hard disc or diskettes, solid state memory such as a USB memory stick, flash memory etc.

What is claimed is:

1. Method for managing the connection in a connection-oriented in-order delivery environment, wherein
a) a client requests establishing a connection by sending a first type of message to a server;
b) the server confirms the ability of establishing the connection by sending to the client a second type of message leading to the server being connected;
c) wherein sending the first type of message starts a first client timer measuring a first predefined time period as a first maximum response time and receiving the second type of message or a data message stops the first client timer; and
d) wherein the connection is closed by sending a third type of message.

2. Method according to claim 1, wherein
if the first predefined time period expires, without a second type of message being received, another first type of message is sent.

3. Method according to claim 1, wherein
the server returns an error message if the server cannot accept a connection.

4. Method according to claim 1, wherein
a) receiving the second type of message leads to the client being connected; and
b) the client sends a fourth type of message to the server to confirm the reception of the second type of message.

5. Method according to claim 4, wherein
sending of the second type of message starts a first server timer measuring a second predefined time period as a second maximum response time and receiving the fourth type of message stops the first server timer.

6. Method according to claim 1, wherein
in case the server is not able to establish a connection it sends a fifth type of message to the client leading to the client being not connected.

7. Method according to claim 1, wherein sending the third type of message starts a second client timer measuring a third predefined time period as third maximum response time.

8. Method according to claim 1, wherein
the server confirms the reception of the third type of message by sending a sixth type of message.

9. Method according to claim 8, wherein
sending of the sixth type of message starts a second server timer measuring a fourth predefined time period as fourth maximum response time.

10. Method according to claim 7, wherein
receiving the sixth type of message at the client stops the second client timer; and
causes the client to send a fourth type of message.

11. Method according to claim 1, wherein sending the third type of message by the server starts a second server timer measuring a third predefined time period as third maximum response time.

12. Method according to claim 1, wherein
the client receiving the third type message confirms the reception of the third type of message by sending a sixth type of message.

13. Method according to claim 12, wherein
sending of the sixth type of message starts a second client timer measuring a fourth predefined time period as fourth maximum response time.

14. Method according to claim 11, wherein
receiving the sixth type of message at the server stops the second server timer; and
causes the client to send a fourth type of message.

15. Method according to claim 1, wherein
at least one of the messages between the client and the server is passing through a router,
wherein the at least one message contains a request for resource reservation; and
the router only forwards the at least one message in case it is able to provide the requested resource.

16. Method according to claim 15, wherein
if the router forwards the at least one message it suspends further resource reservation requests until it receives a second type of message associated to the client server pair involved in establishing the connection associated to the request for resource reservation.

17. Method according to claim 15, wherein
at least one message is used to cancel the resource reservation in case the connection is closed.

18. Method according to claim 15, wherein
the reserved resource is bandwidth.

19. Method according to claim 1, wherein the client and the server respectively establish the connection between a respective application client and a respective application server.

20. System for managing a connection in a connection-oriented in-order delivery environment comprising:
a server,
a client,
a network with in-order delivery; wherein the server is adapted to perform any of the activities of the method according to claim 1 associated to the server and the client is adapted to perform any of the activities of the method according to claim 1 associated to the client.

21. System according to claim 20, comprising a router, wherein at least one of the messages between the client and the server is passing through the router,
wherein the at least one message contains a request for resource reservation; and
the router only forwards the at least one message in case it is able to provide the requested resource.

22. System according to claim 21, wherein
if the router forwards the at least one message it suspends further resource reservation requests until it receives a second type of message associated to the client server pair involved in establishing the connection associated to the request for resource reservation.

23. System according to claim 20, wherein the server and the client respectively comprise only one timer to implement respective the server timers and the client timers.
